(19) United States
(12) Patent Application Publication
(10) Pub. No.: US 2019/0018823 A1
(43) Pub. Date: Jan. 17, 2019

(54) INFORMATION PROCESSING DEVICE, INFORMATION PROCESSING METHOD, AND RECORDING MEDIUM

(71) Applicant: NEC Corporation, Minato-ku, Tokyo (JP)

(72) Inventors: Akihiro YABE, Tokyo (JP); Ryohei FUJIMAKI, Tokyo (JP)

(73) Assignee: NEC Corporation, Minato-ku, Tokyo (JP)

(21) Appl. No.: 16/069,938

(22) PCT Filed: Feb. 1, 2017
(86) PCT No.: PCT/JP2017/003638

§ 371 Date: Jul. 13, 2018

Related U.S. Application Data
(60) Provisional application No. 62/290,564, filed on Feb. 3, 2016.

(51) Int. Cl. G06F 17/16; G06F 17/50

(52) U.S. Cl. CPC G06F 17/16; G06N 99/005; G06F 2217/16; G06F 17/5009

(57) ABSTRACT

An information processing device according to one aspect of the present invention includes: a memory; and at least one processor coupled to the memory wherein, the processor performing operation, the operation comprising: acquiring an optimization model for calculating an optimum solution considering variation in one or more parameters; calculating the optimum solution in the optimization model; transforming the optimization model based on the optimum solution; and outputting the optimum solution.

### TECHNICAL FIELD

The present invention relates to information processing, and particularly relates to an information processing device, an information processing method, and a recording medium that are related to calculation of information (data) satisfying a predetermined condition.

### BACKGROUND ART

An information processing device or an information processing system that provides a user with optimum information (e.g. a quantity of materials charged into a plant, an operation volume at operation equipment, or a set price of a commodity) under a predetermined condition, based on a great deal of information, has been used in recent years. Alternatively, an information processing device or an information processing system that provides information (e.g. a determination indicator) for a user to make a final selection has been used.

In controlling a power generation system including a plurality of power plants, an electric power company needs to determine a power generation amount satisfying a predetermined condition (e.g. minimizing costs while satisfying a total power demand) at each power plant. Accordingly, for example, the electric power company generates an optimization model modeling a power generation system based on a demand prediction (a prediction of a total power demand). Then, in order to determine an optimum power generation amount (optimum solution), the electric power company calculates an optimum solution (power generation amount) in the optimization model by use of a predetermined device or system.

Further, in material purchasing in a production activity, a purchasing department of a company needs to determine a purchase amount of materials (optimum solution) maximizing a profit (minimizing purchase costs) while satisfying a production plan or the like. Accordingly, the purchasing department generates an optimization model modeling a purchase amount based on a demand prediction (e.g. a prediction of a required amount of materials). Then, in order to determine the purchase amount, the purchasing department calculates an optimum solution (purchase amount) in the generated optimization model by use of a predetermined device or system.

A technology by which software or a predetermined device optimally makes a prediction-based determination or plan as described above will be described below by use of a specific example of the technology.

First, an optimization model being a target of optimization processing is determined. The optimization model includes an “objective function” representing an objective of specific optimization and a “constraint” being a condition in calculation of an optimum solution. The “objective function” is expressed as a function of a “target variable.” The “target variable” is a target of the optimization. In the optimization, the aforementioned software or device optimizes a value of the “target variable” in such a way as to optimize (e.g. maximize or minimize) a value of the objective function while satisfying the constraint. A value of the optimized target variable is hereinafter referred to as an “optimum solution.” The optimum solution is a future value. Accordingly, the objective function includes a prediction model expressed by use of a predetermined variable and a predetermined parameter.

The prediction model is a model indicating a relationship between a variable being a prediction target (hereinafter referred to as an “explained variable”) and a variable possibly influencing the prediction target (hereinafter referred to as an “explanatory variable”). In general, an explained variable is expressed as a function using an explanatory variable in the prediction model.

As described above, the term “explained variable” is used for a variable being a prediction target in a prediction.

On the other hand, the term “target variable” is used for a variable being an optimization target in optimization processing.

Thus, the term “explained variable” and the term “target variable” are distinguished from each other and used in the following description.

Note that the prediction model is generated based on, for example, machine learning using a past explanatory variable and a past explained variable, or the like. General methods of generating a prediction model include, for example, “regression analysis.”

Then, the information processing device calculates a value of a target variable (optimum solution) optimizing (e.g. maximizing) the objective function as an optimum solution in the optimization model. At least part of the explanatory variables in the prediction model may become a target variable (a variable being a target of optimization) in the optimization model. This point will be described later by use of a specific example of price optimization.

Further, in general, a range of values that can be taken by a target variable has a limitation. For example, the aforementioned power generation amount at a power plant has an upper limit. Such a limitation is an example of a “constraint.” However, the constraint may include another condition.

Accordingly, for example, the information processing device calculates an optimum solution maximizing a value of the objective function within a range satisfying a predetermined constraint.

As described above, an optimization model used as a target of optimization by an information processing device calculating an optimum solution is a model including an objective function and a constraint.

Since an optimization model is processed by an information processing device, in general, the optimization model is expressed by use of a form (usually a numerical expression expressed by use of a variable) allowing the information processing device to handle the aforementioned objective function and constraint.

Then, under the constraint included in the optimization model, the information processing device calculates, as an optimum solution, a value of a target variable optimizing (maximizing or minimizing) a value of the objective function.

When an objective function included in an optimization model is expressed by use of a linear function of a target variable, the optimization model is referred to as a “linear optimization model.” Further, when an objective function included in an optimization model is expressed by use of a quadratic function of a target variable, the optimization model is referred to as a “quadratic optimization model.”

As a specific example, an optimization model of price optimization related to setting a price of each of a plurality of commodities or services in order to optimize a total sales amount of the commodities or services will be described. An example of using commodities will be described below.

A total sales amount is a sum total of products of prices of the respective commodities and sales volumes (sales quantities) of the commodities. In other words, the total sales amount becomes “the total sales amount =the total of (a price of each commodity x a sales volume of the commodity).”

A price of a commodity is a value settable by a seller of the commodity. On the other hand, a sales volume is a value that cannot be determined by a seller and is a future value viewed from a time point of executing optimization processing.

Accordingly, in order to predict a sales volume of a commodity, a prediction model is set by use of, for example, machine learning. It is obvious that a sales volume of a commodity is influenced by a price of the commodity. Accordingly, the sales volume of the commodity is an explained variable in a prediction model predicting the sales volume of the commodity. Further, the price of the commodity becomes an explanatory variable in the prediction model. In other words, the sales volume of the commodity being an explained variable is expressed as a function of the price of the commodity in the prediction model.

Specifically, the explained variable becomes a linear function or a quadratic or higher order function of the price of the commodity. In other words, the explained variable becomes at least a linear function of the price of the commodity (explanatory variable).

The total sales amount (objective function) becomes a product of the “explanatory variable (the price of the commodity)” and the “explained variable (the sales volume influenced by the price of the commodity).” As described above, the explained variable is expressed by use of a function of the explanatory variable (the price of the commodity). Accordingly, the total sales amount (objective function) becomes at least a quadratic function of the price of the commodity (explanatory variable).

The price of the commodity is a target variable in the optimization model. In other words, the total sales amount (objective function) is expressed by use of at least a quadratic function of the target variable (the price of the commodity).

Accordingly, when a total sales amount is optimized by manipulating a price of a commodity as described above, a quadratic optimization model is used as an optimization model.

In this case, for example, a constraint is a stock volume of the commodity.

Note that, as understood from the aforementioned specific example, an explanatory variable (a price of a commodity) in a prediction model may become a target variable (the price of the commodity) in an optimization model, that is, a variable being an optimization target. In other words, note that a variable being a price of a commodity behaves as an explanatory variable in learning processing and prediction processing, and behaves as a target variable in optimization processing.

An optimization model includes one or more parameters in a mathematical expression representing an optimization model. The parameter is a value determined based on past observation data and the like. However, the observation data are data including an error in a measurement. Further, a calculation target of the optimization model is a value (optimum solution) in an undetermined future. In other words, there is a possibility that the optimum solution is calculated in a situation different from a time when past data are generated. Accordingly, the parameter included in the optimization model includes uncertainty.

A technique of calculating an optimum solution in a generally prevalent optimization model does not consider uncertainty in a parameter. Accordingly, there is a possibility that an optimum solution calculated by use of a general optimization model is not optimum when actually applied.

The reason will be described.

As described above, an optimization model includes a parameter. Then, a parameter includes uncertainty. Accordingly, a value of a parameter when a value of an optimum solution is actually applied may be different from a value of a parameter used in calculation of the optimum solution. In this case, there is a possibility that the calculated optimum solution is not an optimum solution when actually applied.

Consequently, a robust optimization model is proposed as one of optimization models considering uncertainty of a parameter (e.g. referring to NPL 1).

The robust optimization model sets a predetermined uncertainty range (e.g. an elliptic domain in a parameter space) to a parameter. Then, an information processing device calculating an optimum solution in the robust optimization model calculates an optimum solution in the uncertainty range. The aforementioned uncertainty with respect to a parameter is also referred to as a “prediction error” or “parameter variation.”

When a value of a parameter at application of an optimum solution is within a range of expected parameter uncertainty, an optimum solution calculated by use of the robust optimization model is able to guarantee a merit of the solution at the application.

An optimization model acquired by applying the robust optimization model to the aforementioned linear optimization model is referred to as a robust linear optimization model. Further, an optimization model acquired by applying the robust optimization model to the quadratic optimization model is referred to as a robust quadratic optimization model.

### CITATION LIST

### Non Patent Literature

NPL 1: Dimitris Bertsimas, David B. Brown, and Constantine Caramanis, “Theory and Application of Robust Optimization,” SIAM (Society for Industrial and Applied Mathematics) Review, Vol. 53, No. 3, pp. 464 to 501, Aug. 5, 2011

### SUMMARY INVENTION

### Technical Problem

However, a suitable solution for a robust optimization model, in particular a quadratic or higher order robust optimization model, is not proposed.

A technique described in NPL 1 mathematically proposes a solution for one form of a robust quadratic optimization model. However, the technique described in NPL 1 is a technique of calculating an optimum solution by use of a matrix acquired by mathematically decomposing a matrix relating to a parameter including uncertainty.

However, the matrix acquired by mathematically decomposing a parameter is not a matrix relating to a value related to an actually existing object (e.g. a sales volume of a commodity). Accordingly, a decomposed matrix cannot be related to actually conceivable uncertainty. In other words, the technique described in NPL 1 is not able to apply a value of uncertainty (variation) in an actual parameter.

In short, the technology described in NPL 1 has an issue such that it is not able to calculate an optimum solution in a robust optimization model to which conceivable uncertainty that actually occurs is applied.

An object of the present invention is to provide an information processing device, an information processing method, and a recording medium that solve the aforementioned issue and calculate an optimum solution in a robust optimization model to which conceivable uncertainty is applied.

### Solution to Problem

An information processing device according to one aspect of the present invention includes: model acquisition means for acquiring an optimization model for calculating an optimum solution considering variation in one or more parameters; optimization means for calculating the optimum solution in the optimization model; model transformation means for transforming the optimization model based on the optimum solution; and output means for outputting the optimum solution.

An information processing method according to one aspect of the present invention includes: acquiring an optimization model for calculating an optimum solution considering variation in one or more parameters; calculating the optimum solution in the optimization model; transforming the optimization model based on the optimum solution; and outputting the optimum solution.

A non-transitory recording medium according to one aspect of the present invention recording, in a computer readable manner, a program causing a computer to execute: processing of acquiring an optimization model for calculating an optimum solution considering variation in one or more parameters; processing of calculating the optimum solution in the optimization model; processing of transforming the optimization model, based on the optimum solution; and processing of outputting the optimum solution.

### Advantageous Effects of Invention

The present invention provides an effect of calculating an optimum solution in a robust optimization model considering conceivable uncertainty.

### BRIEF DESCRIPTION OF DRAWINGS

FIG. 1 is a block diagram illustrating a configuration example of an information processing device according to a first example embodiment of the present invention.

FIG. 2 is a flow diagram illustrating an operation example of the information processing device according to the first example embodiment.

FIG. 3 is a block diagram illustrating a configuration of an information processing device being an example of a hardware configuration, according to the first example embodiment.

FIG. 4 is a block diagram illustrating a configuration example of an information processing device according to a second example embodiment.

FIG. 5 is a block diagram illustrating a configuration example of a model generation unit according to the second example embodiment.

FIG. 6 is a flowchart illustrating an operation example of the model generation unit according to the second example embodiment.

FIG. 7 is a block diagram illustrating a configuration example of an information processing device according to a third example embodiment.

FIG. 8 is a diagram illustrating a first display example in an output unit according to the third example embodiment.

FIG. 9 is a diagram illustrating a second display example in the output unit according to the third example embodiment.

FIG. 10 is a diagram illustrating a relation between a model and data, according to the first example embodiment.

### DESCRIPTION OF EMBODIMENTS

Next, example embodiments of the present invention will be described with reference to drawings.

The respective drawings are for describing the example embodiments of the present invention. However, the present invention is not limited to the description of each drawing. Further, a same numeral is given to similar configurations in the respective drawings, and repeated description thereof may be omitted.

Further, in the drawings used for the following description, a configuration of a part not related to the description of the example embodiments of the present invention may not be described and may not be illustrated. Further, a direction of an arrow in a drawing indicates an example and does not limit a signal direction between blocks.

Further, numerical expressions are used as appropriate in the following description but the example embodiments of the present invention are not limited to the following numerical expressions.

### First Example Embodiment

Next, a first example embodiment of the present invention will be described with reference to drawings.

An information processing device 100 according to the first example embodiment uses an optimization model considering parameter variation (robust optimization model) as an optimization model and calculates an optimum solution in the optimization model. Specifically, the information processing device 100 calculates an optimum solution considering a range of uncertainty (prediction error or variation) in one or more parameters in the optimization model.

### [Description of Terms]

Prior to description of the example embodiments of the present invention, terms used in the following description including those already described will be summarized.

A “prediction model” is a model for calculating a predicted value of predetermined data, based on the predetermined data (data for prediction). For example, a prediction model for predicting a sales volume of a commodity is a model predicting the sales volume from a commodity price. A prediction model is expressed by use of a numerical expression (prediction formula) such as a function.

For example, a prediction model is generated based on machine learning using learning data.

An “explanatory variable” is a variable used as an input in a prediction model. For example, when a prediction model is expressed by use of a function, an explanatory variable is an argument of the function. An explanatory variable is also referred to as an independent variable.

An “explained variable” is a variable determined based on an explanatory variable in a prediction model. In other words, an explained variable is a value calculated by applying an explanatory variable to the prediction model. A prediction model for calculating an explained variable may include an explained variable in a numerical expression or the like included in the model. When an explained variable is expressed as a function of an explanatory variable (and an explained variable), the function relates to a prediction model. An explained variable is also referred to as a dependent variable or a response variable.

For example, in a case of a prediction model predicting a sales volume from a commodity price, the commodity price is an explanatory variable. Further, the sales volume is an explained variable. In this case, the commodity price being an explanatory variable is an operable variable.

An “optimization model” is a model for calculating a value (optimum solution) of a predetermined variable which optimizes (maximizes or minimizes) a value of a predetermined function, based on predetermined data (data for calculation of an optimum solution) and a predetermined condition. In general, an optimization model is expressed as a mathematical expression. An optimization model includes one or more parameters as a mathematical expression. An optimization model is also referred to as an optimization problem.

An optimization model according to the present example embodiment includes the aforementioned prediction model.

An “objective function” is a function representing a value (e.g. a maximum value or a minimum value) being an object of optimization in an optimization model. The objective function may include a prediction model. In this case, the objective function is a function a value of which is directly or indirectly determined based on an explanatory variable and/or an explained variable in the prediction model. An objective function is also referred to as an evaluation function.

A “target variable” is a variable being an optimum solution calculated to optimize a value of an objective function in an optimization model. Accordingly, an optimization model is expressed as a function including a target variable. A target variable in an optimization model includes at least part of explanatory variables in a prediction model included in the optimization model.

A “constraint” is a constraint condition in calculation of an optimum solution in an optimization model. A constraint may include variation to be described below. For example, a constraint is set based on specification by a user. Alternatively, a constraint is previously stored data.

“Variation” is a range of values of a parameter changing based on uncertainty thereof (a range of uncertainty), the parameter being included in an optimization model. Accordingly, a range of “variation” is a range of “uncertainty” of the parameter. An optimum solution is a value calculated based on a prediction using a parameter. Accordingly “variation” is also referred to as a “prediction error.”

For example, it is assumed that an optimization model includes a prediction model predicting a sales volume from a commodity price. Then, it is assumed that the optimization model calculates an optimum solution of the commodity price optimizing a total sales amount being a total of products of commodity prices and sales volumes. In this case, for example, the information processing device 100 receives a parameter of the optimization model or parameter variation, and calculates a commodity price (optimum solution) maximizing the total sales amount.

In the aforementioned example, a function representing the total sales amount is an objective function. Further, the commodity price being a target of the optimum solution is a target variable. A constraint is, for example, a stock quantity of the commodity. The commodity price is an explanatory variable in the prediction model. The sales volume is an explained variable in the prediction model.

As described above, the commodity price is an explanatory variable in the prediction model and is a target variable in the optimization model. Thus, a variable in a model may be a different variable in another model.

The example embodiments of the present invention calculate an optimum solution of a target variable optimizing (maximizing or minimizing) an objective function in an optimization model in a range satisfying a constraint. As an example, it is assumed that an optimum value is a maximum value of an objective function in the following description.

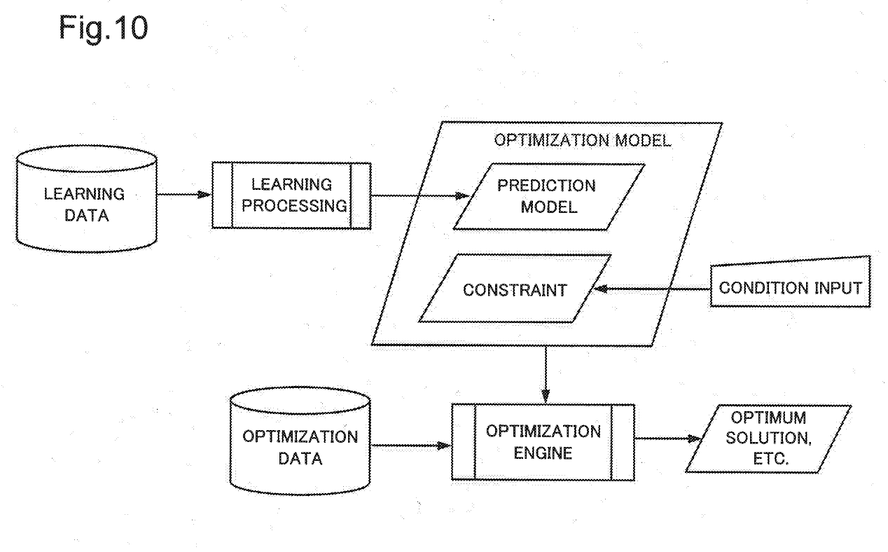

FIG. 10 is a diagram illustrating a relation between the aforementioned model and data. A prediction model is calculated by use of machine learning using learning data, or the like. A constraint is set based on an input operation from a user or the like. An optimization model is set as a model including the prediction model and the constraint. Then, an optimization engine calculating an optimum solution calculates an optimum solution in the optimization model by use of optimization data. The optimization engine may calculate another value (e.g. a value of an objective function) in addition to an optimum solution.

Each example embodiment of the present invention includes at least a configuration operating as an optimization engine.

### [Description of Numerical Expressions]

Next, numerical expressions and variables related to the optimization model according to the first example embodiment will be described.

In the following description, elements of matrices and vectors used as variables in the numerical expressions are real numbers. Further it is assumed that a vector is a column vector.

Note that a vector or a matrix may become a scalar as a result of calculation in the following description. It is assumed that a vector or a matrix includes a case that the number of elements is one.

It is assumed that multiplication with a vector or a matrix in the following description includes a case of multiplication with a scalar.

Note that, in the following description, descriptions of a “vector” and a “matrix” in a variable and a constant may be omitted in order to facilitate understanding of the description.

A vector “x” is a vector representing an explanatory variable in a prediction model. A vector “y” is a vector representing an explained variable in the prediction model. In other words, the vector y being an explained variable is a variable calculated by applying the vector x being an explanatory variable to a predetermined prediction model (prediction formula).

An explained variable may be expressed as a function of an explanatory variable. Further, in an optimization model, an objective function being a target of optimization may be an explained variable in a prediction model. Accordingly, an optimization model may not explicitly include an explained variable.

The number of elements of the vector x is hereinafter denoted as “1 (1 being a positive integer).” The number of elements of the vector y is denoted as “m (m being a positive integer).”

The vector x is replaceable with a basis function [g(x)] in a vector space as appropriate. In other words, the basis function g(x) is an explanatory variable. The number of elements (n) of the basis function g(x) is “n=1+1.” A relation between the vector x and the basis function g(x) is expressed as mathematical expression 1 below.

g(x)=(1,x₁,x₂,K,xᵢ)^{T} [Mathematical expression 1]

In mathematical expression 1, “xᵢ (i=1, 2, . . . , 1)” denotes an i-th element of the vector x. A superior “T” denotes a transposition of a matrix. In a case of a vector, “T” denotes a transformation between a column vector and a row vector. In other words, the basis function g(x) is a column vector.

Each example embodiment calculates a vector x or a basis function g(x) that optimizes (maximizes or minimizes) an objective function in an optimization model. Accordingly, the vector x or the basis function g(x) is a target variable in the optimization model.

### (1) Linear Optimization

A general optimization model (linear optimization model) is expressed by use of mathematical expression 2 indicated below.

$${max}_{x} {c}_{0}^{T} x \\ s . t . Ax \leq b \qquad [ Mathematical expression 2 ]$$

In mathematical expression 2, the first expression is a formula representing an optimization target (i.e. an objective function). Note that “c₀^{T}x” in the first expression relates to a prediction model.

The second expression is an inequality representing a constraint.

An inequality sign (≤) in the second expression indicates that each element in a vector resulting from Ax is less than or equal to each element in a vector b.

As already described, the vector x denotes a vector being an explanatory variable in a prediction model. The vector “c₀” denotes a preset column vector and indicates a relation between the vector x and an objective function.

In the case of mathematical expression 2, the objective function does not explicitly include an explained variable (vector y). However, in this case, the explained variable may be considered to be the prediction model included in the objective function. In other words, in this case, the vector y being an explained variable may be expressed as “y=c₀^{T}x.” In this case, the explained variable (vector y) is specifically a scalar.

Then, the first expression (objective function) in mathematical expression 2 specifically indicates acquiring a vector that maximizes a sum total of products of respective elements of the vector x and the vector c₀ that are explanatory variables in the prediction model.

For example, it is assumed that the vector x denotes a vector having a purchase quantity of each commodity as an element. It is further assumed that the vector c₀ denotes a vector having a price of each commodity as an element. In this case, the first expression (objective function) in mathematical expression 2 indicates calculating a “purchase quantity (vector x)” maximizing total sales.

The second expression representing the constraint indicates a relation (magnitude relation) between an element of the vector on the left-hand side and an element of the vector on the right-hand side.

The vector “b” denotes a vector representing a constraint value. A matrix A denotes a matrix indicating a relation between the explanatory variable (vector x) and the constraint value (vector b). The vector b and the matrix A are previously given information (variables). The explanatory variable (vector x) is a target variable in the optimization model. Accordingly, the constraint is also a constraint of the target variable.

For example, it is assumed that the matrix A is a diagonal matrix with a value of each diagonal element being “1.” Then, it is assumed that the vector x being an explanatory variable represents purchase quantities of the respective commodities. In this case, the vector b in the second expression represents, for example, purchasable quantities of the respective commodities.

The optimization model indicated by mathematical expression 2 is a model for which existence of a calculation of an optimum solution is guaranteed.

### (2) Quadratic Optimization

A general quadratic optimization model is expressed by use of mathematical expression 3 indicated below.

$${max}_{x} {g ( x )}^{T} {Q}_{0} g ( x ) \\ s . t . Ax \leq b \qquad [ Mathematical expression 3 ]$$

Description of the same variables in mathematical expression 3 as those in mathematical expression 2 is omitted. Mathematical expression 3 uses a basis function g(x) in place of a vector x as an explanatory variable in a prediction model.

Mathematical expression 3 is a quadratic expression of the basis function g(x) being an explanatory variable. Mathematical expression 3 is expressed by use of a matrix Q₀ in place of the vector c₀ in mathematical expression 2. The matrix Q₀ is a preset matrix.

For example, the number of elements of the matrix Q₀ is set based on the basis function g(x). For example, the number is set in such a way as to provide the following objective function.

In mathematical expression 3, the vector y being an explained variable in the prediction model is expressed as “y=Q₀g(x).” In other words, the objective function [g(x)^{T}Q₀g(x)] is the product of an explanatory variable [g(x)^{T}] in the prediction model and the explained variable [Q₀g(x)]. In other words, the explained variable [vector y=Q₀g(x)] relates to the prediction model.

When dimensions of the basis function g(x) and the vector y are different, either the vector y or the matrix Q₀ may additionally include a required number of zero elements (elements each having a value “0”) or zero rows (rows every element of which having a value “0”) for calculation.

Mathematical expression 3 is a mathematical expression representing an optimization model acquiring a vector x that maximizes the first expression (objective function) under a constraint being the second expression.

The optimization model represented by mathematical expression 3 is a model for which existence of a calculation of an optimum solution is guaranteed. Additionally, the constraint in the aforementioned optimization model is not limited to the aforementioned linear constraint (Ax≤b). For example, even when the constraint is an integral constraint, existence of a calculation of an approximate solution with any approximation precision is guaranteed for the aforementioned optimization model.

The “integral constraint” is a constraint under which at least part of an optimum solution is an integer.

### (3) Robust Optimization Model (Robust Linear Optimization Model)

A linear robust optimization model is expressed by use of mathematical expression 4 below.

$${max}_{x} {min}_{u} {c}^{T} x \\ s . t . Ax \leq b \\ c = {c}_{0} + Lu \\ ‖ u ‖ \leq λ \qquad [ Mathematical expression 4 ]$$

Description of the same variables in mathematical expression 4 as those in mathematical expression 2 is omitted. A vector “u” is a vector indicating uncertainty in a parameter (c₀) (e.g. variation in an element of a vector c₀). Vertical double lines denote a norm (generalizing a length of a geometric vector into a distance in a vector space). A variable “λ” denotes a constraint related to variation. A matrix “L” denotes a matrix setting a range in which c₀ varies (a domain in which c₀ changes) according to the variation vector u. The matrix L is a regular matrix. The matrix L and the variable λ are previously given variables.

The first expression in mathematical expression 4 indicates calculating a vector x that maximizes a minimum value of an objective function (c^{T}x) in variation based on the variation vector u. In other words, the first expression indicates calculating, as an optimum solution, a vector x that maximizes a minimum value of the objective function in a variation range set to the vector c₀.

Various solutions are proposed for the robust optimization model (robust linear optimization model) indicated in mathematical expression 4.

### (4) Robust Optimization Model (Robust Quadratic Optimization Model)

A robust quadratic optimization model, to be described in detail later, being an optimization model related to the example embodiments of the present invention is expressed by use of mathematical expression 5 below.

$${max}_{x} {min}_{U} {g ( x )}^{T} Qg ( x ) \\ s . t . Ax \leq b \\ Q = {Q}_{0} + L ( U ) \\ {‖ U ‖}_{F} \leq λ \qquad [ Mathematical expression 5 ]$$

Description of the same variables in mathematical expression 5 as those in mathematical expression 2 or 4 is omitted.

A matrix “U” is a matrix representing variation in a parameter (matrix Q₀) relating to the variation vector u in mathematical expression 4. “F” indicated in a norm in the fourth expression denotes a Frobenius norm.

A function “L( )” denotes a function of a matrix relating to the matrix L in mathematical expression 4. The function L( ) is a function representing variation based on the variation matrix U, the function being added to the matrix Q₀. In other words, a matrix Q in mathematical expression 5 is acquired by adding variation represented by the function L(U) to the matrix Q₀. A variable λ and the function L( ) are previously given.

A constraint in the optimization model indicated in mathematical expression 5 is not limited to the aforementioned linear constraint (Ax≤b). For example, the constraint in the aforementioned optimization model may include an integral constraint.

The first expression (objective function) in mathematical expression 5 indicates calculating, as an optimum solution, a vector x that maximizes a minimum value of the objective function in a variation (matrix U) range. In other words, the first expression determines, as an optimum solution, a vector x that maximizes a minimum value in a variation range set to Q₀.

As already described, a suitable solution for robust optimization as indicated in the aforementioned mathematical expression 5 is not proposed. For example, the technique described in NPL 1 is a technique capable of calculating a solution when the matrix Q in mathematical expression 5 can be decomposed into a mathematically set matrix TTT. However, the matrix T acquired by decomposing the matrix Q is a matrix introduced for calculation. Accordingly, actually expected uncertainty cannot be applied to the matrix T.

The example embodiments of the present invention are not required to decompose the matrix Q as described above, and are able to calculate an optimum solution to which uncertainty in an actual optimization target is applied and provide a user with the solution.

### [Description of Configuration]

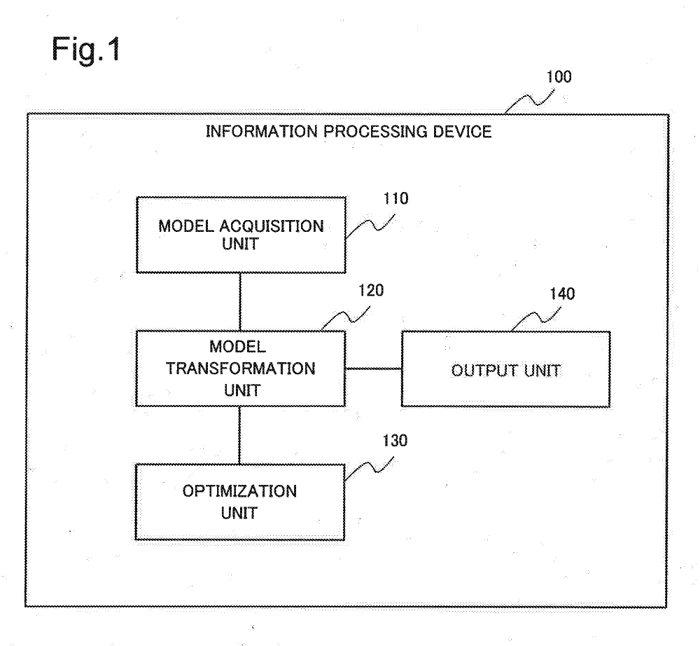

Next, a configuration of the information processing device 100 according to the first example embodiment of the present invention will be described. FIG. 1 is a block diagram illustrating a configuration example of the information processing device 100 according to the first example embodiment.

As illustrated in FIG. 1, the information processing device 100 according to the first example embodiment includes a model acquisition unit 110, a model transformation unit 120, an optimization unit 130, and an output unit 140.

The model acquisition unit 110 acquires an optimization model being a target of optimization processing in the information processing device 100. The optimization model will be described below by use of a robust quadratic optimization model as an example.

Acquisition of an optimization model specifically means acquiring a mathematical expression related to the optimization model as indicated in mathematical expression 5. Acquisition of a mathematical expression includes acquisition of a coefficient and a constant term included in the mathematical expression.

The method of the model acquisition unit 110 acquiring an optimization model is not particularly limited.

For example, the model acquisition unit 110 may directly receive (acquire) an optimization model.

Alternatively, the model acquisition unit 110 may receive a parameter and the like and generate an optimization model. For example, the operation is an operation as described below.

For example, the model acquisition unit 110 receives a general quadratic optimization model (prediction model) and a parameter for robust optimization. Then, the model acquisition unit 110 may apply the parameter to the general quadratic optimization model (prediction model) and generate an optimization model.

Alternatively, the model acquisition unit 110 stores a prediction model (type) being an origin of an optimization model. Then, the model acquisition unit 110 receives a parameter and a constraint in the optimization model. Then, the model acquisition unit 110 may modify the prediction model (type) by use of predetermined processing (e.g. machine learning) and then generate the optimization model by applying the parameter and the constraint.

Alternatively, the model acquisition unit 110 previously stores information about a model (prediction prototype model) being a prototype of a general quadratic optimization model (prediction model). Then, the model acquisition unit 110 receives a parameter (prediction model parameter) related to the prediction prototype model. Then, the model acquisition unit 110 generates a general quadratic optimization model (prediction model) by applying the prediction model parameter to the prediction prototype model. Additionally, the model acquisition unit 110 receives a parameter of an optimization model. Then, the model acquisition unit 110 may generate the optimization model by applying the received parameter to the generated general quadratic optimization model.

An acquisition source from which the model acquisition unit 110 acquires the aforementioned information (a parameter or a model) is not particularly limited. The model acquisition unit 110 may receive the aforementioned information from an unillustrated external device (e.g. a device operated by a user of the information processing device 100).

Alternatively, the model acquisition unit 110 may acquire the aforementioned information from an unillustrated storage unit.

The model acquisition unit 110 transmits the acquired or generated optimization model to the model transformation unit 120.

The model transformation unit 120 requests calculation of an optimum solution in an optimization model to the optimization unit 130. Then, the model transformation unit 120 transforms the optimization model by use of the optimum solution calculated by the optimization unit 130. The transformation of an optimization model is not particularly limited. For example, transformation of an optimization model is modification of a form of a mathematical expression related to the optimization model, or change of a value of a parameter included in the optimization model. The transformation will be described below by use of change of a value of a parameter as an example.

Then, the model transformation unit 120 requests calculation of an optimum solution in the transformed optimization model to the optimization unit 130. The model transformation unit 120 repeats the operation of the aforementioned change and calculation until the optimum solution or a processing state (e.g. a count of the optimum solution calculation processing) satisfies a predetermined condition.

The predetermined condition is not particularly limited. The predetermined condition may be determined based on an optimization model being a target. For example, in a case that will be described in Detailed Operation, a predetermined condition may use the number of repetitions of the aforementioned operation. Alternatively, in the case described above, the predetermined condition may be that an amount of change being a difference between a calculated optimum solution and an optimum solution calculated the previous time is less than a predetermined value.

When the predetermined condition is satisfied, the model transformation unit 120 transmits the optimum solution to the output unit 140.

The optimization unit 130 calculates an optimum solution in an optimization model received from the model transformation unit 120. The optimization unit 130 transmits the optimum solution to the model transformation unit 120.

The output unit 140 outputs an optimum solution (an optimum solution satisfying a predetermined condition in an optimization model) received from the model transformation unit 120 to a predetermined output destination. For example, the output unit 140 may output the optimum solution to an unillustrated device transmitting a parameter to the model acquisition unit 110.

### [Description of Operation]

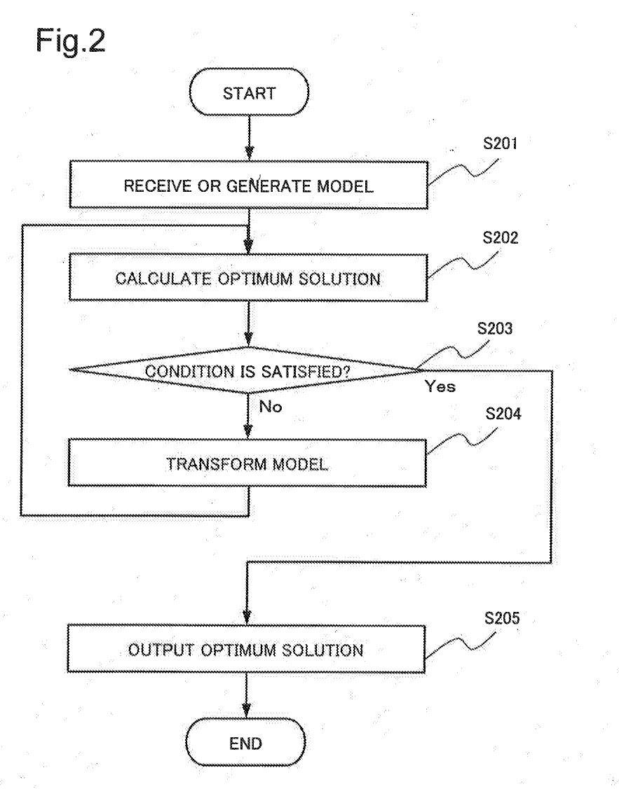

Next, an operation of the information processing device 100 according to the first example embodiment will be described with reference to a drawing. FIG. 2 is a flowchart illustrating an operation example of the information processing device 100 according to the first example embodiment.

First, the model acquisition unit 110 receives (acquires) or generates an optimization model being a processing target (Step S201).

The model acquisition unit 110 transmits the optimization model to the model transformation unit 120.

The model transformation unit 120 calculates an optimum solution in the optimization model by use of the optimization unit 130 (Step S202).

The model transformation unit 120 determines whether or not a predetermined condition is satisfied (Step S203).

When the condition is not satisfied (No in Step S203), the model transformation unit 120 transforms the optimization model (Step S204). Then, the model transformation unit 120 returns to Step S203.

When the condition is satisfied (Yes in Step S203), the model transformation unit 120 transmits the optimum solution to the output unit 140.

The output unit 140 outputs the optimum solution to a predetermined output destination (Step S205).

Then, the information processing device 100 ends the operation.

### [Detailed Operation]

Next, details of the operation of the information processing device 100 will be described by use of a mathematical expression related to an example of a robust quadratic optimization model related to the aforementioned mathematical expression 5. The mathematical expression used by the information processing device 100 according to the present example embodiment is not limited to the mathematical expression indicated below.

It is assumed in the following description that the function L(U) in mathematical expression 5 can be expressed or approximated by use of two matrices L₁ and L₂ as indicated in mathematical expression 6 below.

L(U)=L₁^{T}UL₂ [Mathematical expression 6]

Mathematical expression 6 uses a matrix U representing variation. In other words, the information processing device 100 calculates an optimum solution by use of actually occurring variation.

The model acquisition unit 110 acquires or generates the optimization model indicated in mathematical expression 5. It is assumed in the following description that the model acquisition unit 110 previously stores a form (type) of the numerical expressions indicated in mathematical expression 5. It is assumed that the function L(U) has a form of mathematical expression 6. Then, the model acquisition unit 110 receives parameters indicated in mathematical expressions 5 and 6. Specifically, the model acquisition unit 110 receives the following parameters:

Matrices: Q₀, A, L₁, and L₂;

Vector: b; and

Constant: λ.

It is assumed that a basis function g(x) is that in mathematical expression 1.

The model acquisition unit 110 generates an optimization model relating to mathematical expression 5 by use of the received parameters.

The model acquisition unit 110 according to the present example embodiment introduces matrices M₁ and M_{2,} and a variable γ that are indicated in mathematical expression 7, and generates mathematical expression 8 being a modified example of mathematical expression 5.

As will be described later, the model transformation unit 120 updates the variable γ. Then, an initial value of the variable γ is denoted as an initial value γ₀. The initial value γ₀ is not particularly limited as long as the value is a positive real number. The model acquisition unit 110 may use a preset initial value γ₀. Alternatively, the model acquisition unit 110 may acquire an initial value γ₀ included in the received parameters.

The updated variable γ is denoted as a variable γᵢ (i=1, 2, . . . ) added with a variable i indicating a sequence number.

$$\begin{matrix} {M}_{1} := {L}_{1}^{T} {L}_{1} \\ {M}_{2} := {L}_{2}^{T} {L}_{2} & [ Mathematical expression 7 ] \\ {max}_{x} {g ( x )}^{T} ( {Q}_{0} - \frac{{γ}_{i}^{2} {M}_{1} + {M}_{2} / {γ}_{i}^{2}}{2} λ ) g ( x ) \\ s . t . Ax \leq b & [ Mathematical expression 8 ]\end{matrix}$$

As is obvious from mathematical expression 8, the variable λ, is included in the first expression (objective function) in mathematical expression 8. Additionally, as is obvious from a comparison with mathematical expression 3, mathematical expression 8 has the same type as a general quadratic optimization model. In other words, existence of a calculation of an optimum solution is guaranteed for mathematical expression 8. In other words, the model acquisition unit 110 generates an optimization model for which existence of an optimum solution is guaranteed.

Thus, the information processing device 100 according to the present example embodiment generates, as an optimization model (robust quadratic optimization model), an optimization model for which existence of a calculation of an optimum solution is guaranteed.

The model acquisition unit 110 transmits the generated optimization model to the model transformation unit 120.

The model transformation unit 120 calculates an optimum solution in the received optimization model by use of the optimization unit 130. As described above, a solution for an optimum solution is guaranteed for the optimization model. Accordingly, the optimization unit 130 is able to calculate an optimum solution.

The calculation method of an optimum solution in the optimization unit 130 is not particularly limited. The optimization unit 130 may use a commonly used calculation method of an optimum solution in a quadratic optimization model.

After the optimization unit 130 calculates an optimum solution, the model transformation unit 120 determines whether or not the optimum solution satisfies a predetermined condition (e.g. a processing count).

When the predetermined condition is satisfied, the model transformation unit 120 ends the processing and transmits the optimum solution to the output unit 140.

When the predetermined condition is not satisfied, the model transformation unit 120 transforms the optimization model. More specifically, the model transformation unit 120 adjusts the variable γᵢ. The adjustment of the variable γᵢ is not particularly limited. For example, the model transformation unit 120 may change (adjust) the variable γᵢ by use of mathematical expression 9 indicated below.

γᵢ₊₁:=\sqrt{∥L₂x_{γi}∥/∥L₁x_{γi}∥} [Mathematical expression 9]

In mathematical expression 9, a vector “x_{γi}” is a vector x calculated by use of the variable γᵢ. For example, the first vector x_{γ0} is a vector x calculated by use of the initial value γ₀ of the variable γ. Further, a vector x_{γ1} is a vector x calculated by use of a variable γ₁ being changed once.

The model transformation unit 120 transforms the optimization model by exchanging the variable γᵢ in mathematical expression 8 for a calculated variable γᵢ₊₁. In other words, the model transformation unit 120 transforms the optimization model by use of a calculated optimum solution.

Then, the model transformation unit 120 requests the optimization unit 130 to calculate an optimum solution in the transformed optimization model.

The optimum solution in mathematical expression 8 is guaranteed to be non-decreasing with respect to the adjustment of the variable γ.

The reason is as follows. As indicated in mathematical expression 9, when changing γ (changing from γᵢ to γᵢ₊₁) resulting in γᵢ₊₁≠γᵢ, a value of the first expression (objective function) in mathematical expression 8 increases. Further, as a matter of course, the objective function in mathematical expression 8 takes the same value in a case of γᵢ₊₁=γᵢ. In other words, when γ is changed in accordance with mathematical expression 9 in the objective function in mathematical expression 8, the objective function in mathematical expression 8 is non-decreasing with respect to the change of γᵢ. Further, when being maximized with respect to x while γ is fixed to any value, a value of the objective function in mathematical expression 8 is maximized with respect to x and therefore is non-decreasing. Accordingly, a calculation of an optimum solution in the objective function in mathematical expression 8 when γ is changed in accordance with mathematical expression 9 is non-decreasing.

Accordingly, by repeating the aforementioned operations by the model transformation unit 120 and the optimization unit 130 a sufficiently large number of times, the information processing device 100 is able to calculate an optimum solution (a target variable maximizing a minimum value of the objective function) or an approximate solution of the optimum solution in a variation range.

Thus, the model transformation unit 120 transforms the optimization model in such a way as to search for a minimum value in a parameter variation range. Then, the optimization unit 130 calculates an optimum solution in the optimization model. The information processing device 100 may repeat the operations.

Then, the predetermined condition is a condition for guaranteeing existence of a calculation of an optimum solution in a variation range (a range of a prediction error). An optimum solution or an approximate value of the optimum solution can be calculated by the model transformation unit 120 and the optimization unit 130 repeating the aforementioned operations until the predetermined condition is satisfied. For example, the predetermined condition may be set based on a past result.

### [Description of Effects]

Next, an effect of the first example embodiment will be described.

The information processing device 100 according to the first example embodiment provides an effect of calculating an optimum solution in an optimization model a (a robust optimization model, in particular a robust quadratic optimization model) considering parameter variation (matrix U). In other words, the information processing device 100 provides an effect of calculating an optimum solution in a robust optimization model to which conceivable uncertainty is applied.

The reason is as follows.

The model acquisition unit 110 acquires or generates an optimization model (robust quadratic optimization model) being an optimization target. As described above, the model acquisition unit 110 generates an optimization model for which existence of an optimum solution is guaranteed. Additionally, the optimization model is a model using the matrix U representing variation.

Then, by use of the optimization unit 130, the model transformation unit 120 calculates an optimum solution in the optimization model for which existence of a calculation of an optimum solution is guaranteed.

Furthermore, the model transformation unit 120 transforms the optimization model by use of a calculated optimum solution until a predetermined condition is satisfied. Then, the optimization unit 130 calculates an optimum solution in the transformed optimization model. With respect to the transformation of the optimization model in the model transformation unit 120, an optimum solution in the related optimization model (optimization problem) is non-decreasing.

Further, the objective function in mathematical expression 8 always overestimates a risk in mathematical expression 5.

The reason is that, for any set of x and y being substituted, a value of the objective function in mathematical expression 8 is less than or equal to a value acquired by substituting the same x into the objective function in mathematical expression 5.

Furthermore, transformation of the optimization model in the model transformation unit 120 relates to adjustment of an estimation of a risk in a current solution (x_{γi}) to match mathematical expression 5.

The reason is as follows. As described above, the objective function in mathematical expression 8 is less than or equal to the objective function in mathematical expression 5 for any set of x and γ. However, when the set of x and γ satisfies the relation in mathematical expression 9, the value of the objective function in mathematical expression 8 matches the value of the objective function in mathematical expression 5.

Accordingly, the information processing device 100 is able to calculate an optimum solution or an approximate value of the optimum solution in an evaluation of a risk equivalent to mathematical expression 5, by using a condition of repeating the processing a sufficient number of times on a variation range (prediction error range).

### SPECIFIC APPLICATION EXAMPLES

In order to facilitate understanding of the information processing device 100 according to the first example embodiment, application examples of the information processing device 100 according to the first example embodiment will be described below by use of simple specific examples.

The optimization model described in Detailed Operation by use of mathematical expression 6 or 9 is applicable to the application examples described below. An initial value of a parameter and the like in the optimization model may be set based on knowledge or the like about each example.

### (1) First Application Example

First, as a first application example, a case of the information processing device 100 calculating an optimum solution for prices of a plurality of commodities in such a way as to maximize a sum total of sales amounts of the plurality of commodities, based on a prediction of sales of the plurality of commodities will be described.

As a more specific example, a case of the information processing device 100 calculating an optimum solution (sales price) maximizing a sum total of sales amounts of a sandwich group over the next month at a retail store is considered. It is assumed that the sandwich group includes four kinds of sandwiches being sandwiches A, B, C, and D. In this case, the information processing device 100 solves a problem of calculating an optimum solution for respective sales prices of the sandwiches A, B, C, and D, the optimum solution maximizing the sum total of sales amounts of the sandwich group.

For example, the sales volume of the sandwich A is considered to be influenced by the sales prices of the sandwiches (sandwiches B, C, and D) displayed on a display shelf along with the sandwich A, in addition to a sales price of the sandwich A itself. The reason is that a customer visiting the retail store is considered to selectively purchase a preferred sandwich out of the sandwiches A, B, C, and D that are simultaneously displayed on the display shelf.

For example, a day when the sales price of the sandwich B is set lower than the sales price usually set is assumed. In this case, it is predicted that a possibility of a customer purchasing the sandwich B is higher compared with a day when the sales price is set at the usual price. On the other hand, it is predicted that a possibility of the customer purchasing the other sandwiches (A, C, and D) is lower compared with a day when the sales price is set at the usual price. The reason is that, in general, a commodity (the sandwich B in this case) a sales price of which is set lower than usual provides the customer with a higher incentive to purchase.

In other words, based on the sales price of the sandwich B, sales volumes of the other sandwiches (A, C, and D) decrease. Such a competitive relation among a plurality of commodities is referred to as a cannibalization relation (market cannibalization relation).

Specifically, for example, the cannibalization relation is a relation in which lowering a sales price of a certain commodity increases a sales volume of the commodity but decreases sales volumes of other competing commodities (a plurality of commodities with characters and features similar to one another).

For example, a sales volume of the sandwich A is influenced by not only the sales price of the sandwich A but also the sales prices of the sandwiches B, C, and D.

Accordingly, the sales volume of the sandwich A is expressed by use of a function (a prediction formula or a prediction model) including the sales prices of all the sandwiches (A, B, C, and D). In other words, the function is a prediction model. Then, the sales prices of the sandwich group are explanatory variables (vector x) in the prediction model. The sales volumes of the sandwich group are explained variables (vector y) in the prediction model. The function (the prediction formula or the prediction model) may be calculated based on past data (e.g. a past sales price of each sandwich and a sales volume at the time).

An optimization model is a model including the function (the prediction formula or the prediction model). In other words, the optimization model is calculated based on past data of the explanatory variables and the explained variables. Target variables in the optimization model are the sales prices of the sandwich group.

The optimization model may include another kind of information (e.g. external information). The optimization model may include information about the weather, the temperature, or an event held in a surrounding area, over the next month.

For example, a constraint is a received quantity and a purchase price of each sandwich. Further, an objective function is the sum total of the sales amounts of the sandwich group.

The model acquisition unit 110 acquires the optimization model and transmits the model to the model transformation unit 120.

The model transformation unit 120 transmits the optimization model to the optimization unit 130.

The optimization unit 130 calculates an optimum solution of the sales price (target variable) in such a way as to maximize a minimum value of the objective function (the sum total of the sales amounts of the sandwich group) in a range satisfying constraints on the sales price and the like in the optimization model of the sales amount. More specifically, the optimization unit 130 calculates an optimum solution for the sales price of each of the sandwiches A, B, C, and D.

The minimum value of the objective function is a minimum value of the objective function at a certain parameter. Then, “calculating an optimum solution in such a way as to maximize a minimum value of the objective function” means “calculating a parameter maximizing a minimum value of the objective function.”

The model transformation unit 120 transforms the optimization model, based on the optimum solution.

Then, the model transformation unit 120 and the optimization unit 130 repeat the operations until a predetermined condition is satisfied.

Then, the output unit 140 outputs the optimum solution.

In order to facilitate understanding, the information processing device 100 calculates an optimum solution of a sales price of each of four commodities in such a way as to maximize a sum total of sales amounts of the commodities, in the description above. In other words, the information processing device 100 uses four target variables as target variables in an optimization model. In other words, the information processing device 100 uses four variables as explanatory variables in a prediction model in the optimization model. However, the number of target variables (or explanatory variables in the prediction model) included in the optimization model being a target of the information processing device 100 is not limited to four. The number of the target variables may be two or three, or five or more. Further, a value related to a target variable is not limited to a value related to a tangible commodity. For example, a value of a target variable may be a value related to a service.

### (2) Second Application Example

Next, as a second application example, a case of the information processing device 100 calculating as an optimum solution a price (rate) of a hotel plan (lodging plan) in such a way as to maximize a sales amount or a profit of the hotel will be described.

In this case, an objective function is expressed by use of a function calculating the sales amount or the profit of the hotel. Further, as a target variable (an explanatory variable in a prediction model) in an optimization model, a rate in a plan using each room in the hotel is selected. For example, a constraint is the total number of rooms.

In other words, the information processing device 100 calculates, as an optimum solution, a rate set to a plan in such a way as to maximize a minimum value of the sales amount or the profit of the hotel.

In comparison with the first application example, a “plan (e.g. a plan offering a single room with breakfast)” in the second application example relates to a “sandwich (e.g. the sandwich A)” in the first application example.

### (3) Third Application Example

Next, as a third application example, a case of the information processing device 100 calculating as an optimum solution a price of a room in a hotel and the number of rooms in stock (vacant rooms) in such a way as to maximize a sales amount or a profit of the hotel will be described.

In this case, similarly to the second application example, an objective function is expressed by use of a function calculating the sales amount or the profit of the hotel. Further, as a target variable (an explanatory variable in a prediction model) in an optimization model, a variable related to a price of a room and a variable related to the number of rooms in stock are selected. For example, a first target variable is a variable representing a rate of each room in each period. Further, a second target variable is a variable representing the number of rooms to be sold (or the number of rooms in stock) in each period. For example, a constraint is the total number of rooms.

In other words, the information processing device 100 calculates as an optimum solution a price of a room and the number of rooms to be sold in such a way as to maximize a minimum value of the sales amount or the profit of the hotel.

### (4) Fourth Application Example

Next, as a fourth application example, a case of the information processing device 100 calculating as an optimum solution a price and a stock (seat) quantity of an airline ticket at an airline company in such a way as to maximize a sales amount or a profit of the airline company will be described.

In this case, an objective function is expressed by use of a function calculating the sales amount or the profit of the airline company. Further, as a target variable (an explanatory variable in a prediction model) in an optimization model, variables related to a price of an airline ticket and the number of tickets to be sold (number of seats to be sold) are selected.

It is assumed that airline tickets are classified based on a line (a departure place, a destination, and a route) and a seat type (class). In this case, for example, a first target variable is a variable representing a rate of an airline ticket related to a line and a seat class in each period. Further, a second target variable is a variable representing the number of airline tickets to be sold (number of seats to be sold) in each period.

For example, a constraint is the number of seats in an aircraft used in each line.

In other words, the information processing device 100 calculates as an optimum solution a fare of an airline ticket and the number of tickets to be sold in such a way as to maximize a minimum value of the sales amount or the profit of the airline company.

### (5) Fifth Application Example

Next, as a fifth application example, a case of the information processing device 100 calculating as an optimum solution a parking fee at each parking lot in such a way as to maximize a sales amount or a profit at parking lots will be described.

In this case, an objective function is expressed by use of a function calculating the sales amount or the profit of the parking lots. Further, for example, a target variable (an explanatory variable in a prediction model) in an optimization model is a variable representing a parking fee for each time period and location. For example, a constraint is the number of cars that can be parked at each parking lot.

In other words, the information processing device 100 calculates as an optimum solution a parking fee for each time period and location in such a way as to maximize a minimum value of the sales amount or the profit of the parking lots.

### [Hardware Configuration]

The information processing device 100 as described above is configured as follows.

For example, each unit in the information processing device 100 may be configured with hardware circuitry.

Further, each unit in the information processing device 100 may be configured by use of a plurality of devices connected through a network. In other words, the information processing device according to each example embodiment may be provided as an optimization system.

In this case, each component in each device is provided in part or in whole by use of general-purpose or dedicated circuitry, a processor, or the like, or a combination thereof. Each of the aforementioned components may be configured in part or in whole by use of a single integrated circuit (IC) or chip. Alternatively, each of the aforementioned components may be configured in part or in whole by use of a plurality of integrated circuits connected through a predetermined generating line (bus). Each of the aforementioned components may be provided in part or in whole by use of a combination of the aforementioned circuitry and the like, and a program.

When each component in each device is provided in part or in whole by use of a plurality of information processing devices or pieces of circuitry, or the like, the aforementioned plurality of information processing devices or pieces of circuitry, or the like may be placed in a concentrated manner. Alternatively, the aforementioned plurality of information processing devices or pieces of circuitry, or the like may be placed in a distributed manner. For example, the aforementioned information processing devices or pieces of circuitry, or the like may be provided in a form in which each of the information processing devices or pieces of circuitry, or the like is connected through a predetermined communication network. The aforementioned form is a system such as a client and server system or a cloud computing system.

Further, a plurality of units in the information processing device 100 may be configured with a single piece of hardware.

Further, the information processing device 100 may be provided as a computer device including a central processing unit (CPU), a read only memory (ROM), and a random access memory (RAM). The information processing device 100 may be provided as a computer device including an input/output circuit (IOC) and a network interface circuit (NIC) in addition to the configuration described above.

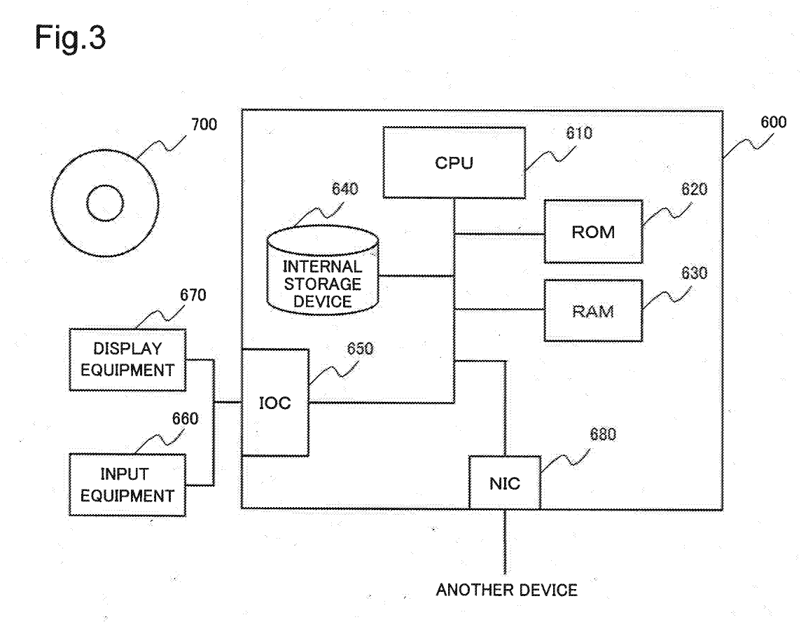

FIG. 3 is a block diagram illustrating a configuration of an information processing device 600 being an example of the hardware configuration according to the present example embodiment.

The information processing device 600 includes a CPU 610, a ROM 620, a RAM 630, an internal storage device 640, an IOC 650, and a NIC 680, and constitutes a computer device.

The CPU 610 reads a program from the ROM 620. Then, the CPU 610 controls the RAM 630, the internal storage device 640, the IOC 650, and the NIC 680 in accordance with the read program. Then, the computer including the CPU 610 controls the configurations and provides the respective functions as the model acquisition unit 110, the model transformation unit 120, the optimization unit 130, and the output unit 140 that are illustrated in FIG. 1.

When providing each function, the CPU 610 may use the RAM 630 or the internal storage device 640 as a temporary recording medium of the program.

Further, the CPU 610 may read a program included in a recording medium 700 embodying the program in a computer readable manner, by use of an unillustrated recording medium reader. Alternatively, the CPU 610 may receive a program from an unillustrated external device through the NIC 680, store the program into the RAM 630, and operate based on the stored program.

The ROM 620 stores a program executed by the CPU 610 and fixed data. For example, the ROM 620 is a programmable-ROM (P-ROM) or a flash ROM.

The RAM 630 temporarily stores a program executed by the CPU 610 and data. For example, the RAM 630 is a dynamic RAM (D-RAM).

The internal storage device 640 stores data and a program that are stored by the information processing device 600 for a long term. Further, the internal storage device 640 may operate as a temporary storage device of the CPU 610. For example, the internal storage device 640 is a hard disk device, a magneto-optical disk device, a solid state drive (SSD), or a disk array device.

The ROM 620 and the internal storage device 640 are non-transitory recording media. By contrast, the RAM 630 is a transitory recording medium. Then, the CPU 610 is able to operate in accordance with a program stored in the ROM 620, the internal storage device 640, or the RAM 630. In other words, the CPU 610 is able to operate by use of a non-transitory recording medium or a transitory recording medium.

The IOC 650 mediates data between the CPU 610, and input equipment 660 and display equipment 670. For example, the IOC 650 is an IO interface card or a universal serial bus (USB) card. Additionally, the IOC 650 may use not only a wired line such as USB but also a wireless line.

The input equipment 660 is equipment receiving an input instruction from an operator of the information processing device 600. The input equipment 660 may operate as the model acquisition unit 110. For example, the input equipment 660 is a keyboard, a mouse, or a touch panel.

The display equipment 670 is equipment displaying information to an operator of the information processing device 600.

The display equipment 670 may operate as the output unit 140. For example, the display equipment 670 is a liquid crystal display.

The NIC 680 relays a data exchange with an unillustrated external device through a network. The NIC 680 may operate as the model acquisition unit 110 or the output unit 140. For example, the NIC 680 is a local area network (LAN) card. Additionally, the NIC 680 may use not only a wired line but also a wireless line.

The thus configured information processing device 600 provides an effect similar to that provided by the information processing device 100.

The reason is that the CPU 610 in the information processing device 600 provides a function similar to that of the information processing device 100, in accordance with a program.

### Second Example Embodiment

The information processing device 100 acquires an optimization model. However, the information processing device 100 may generate an optimization model, based on past data or the like.

Then, as a second example embodiment, an information processing device 101 generating a prediction model by use of machine learning, generating an optimization model based on the generated prediction model, and calculating an optimum solution in the generated optimization model will be described. The information processing device 101 calculates an optimum solution in the generated optimization model by use of a configuration similar to that of the information processing device 100.

### [Description of Configuration]

First, a configuration of the information processing device 101 according to the second example embodiment will be described.

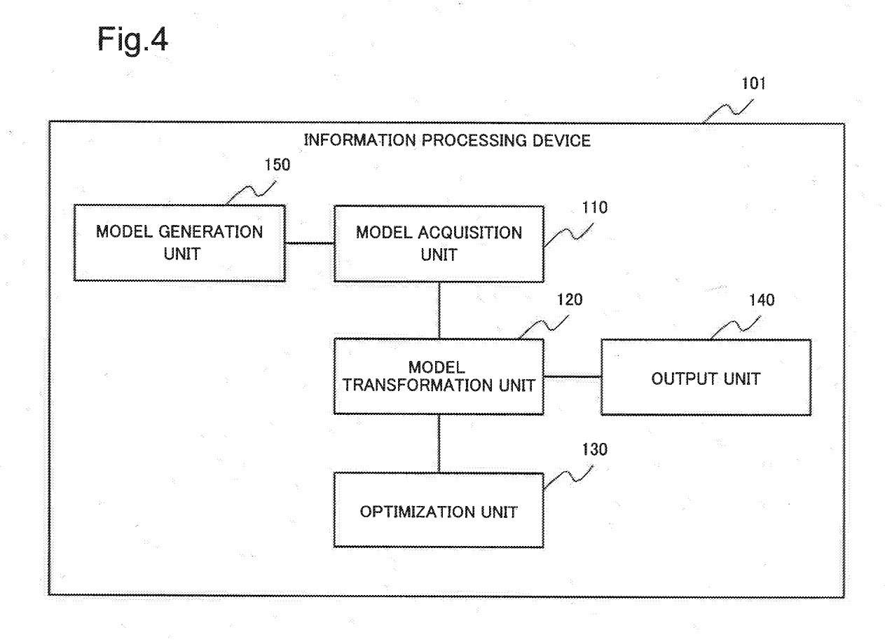

FIG. 4 is a block diagram illustrating a configuration example of the information processing device 101 according to the second example embodiment. As illustrated in FIG. 4, in comparison with the information processing device 100 according to the first example embodiment, the information processing device 101 according to the second example embodiment differs in including a model generation unit 150. Then, the model generation unit 150 will be described in the following description, and description of a configuration similar to that according to the first example embodiment is omitted. Similarly to the information processing device 100, the information processing device 101 may be configured by use of the computer illustrated in FIG. 3.

The model generation unit 150 generates an optimization model and transmits the model to a model acquisition unit 110. The model generation unit 150 may include a function of the model acquisition unit 110. For example, the model generation unit 150 may transfer a generated optimization model to a model transformation unit 120. In this case, the information processing device 101 does not need to include the model acquisition unit 110.

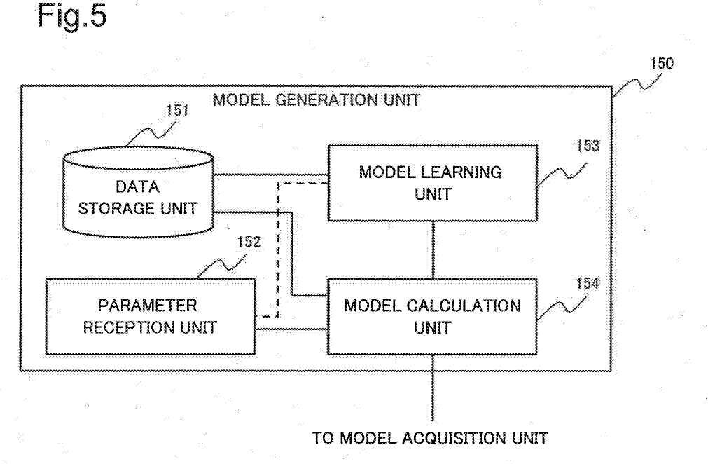

FIG. 5 is a block diagram illustrating a configuration example of the model generation unit 150 according to the second example embodiment. As illustrated in FIG. 5, the model generation unit 150 includes a data storage unit 151, a parameter reception unit 152, a model learning unit 153, and a model calculation unit 154.

The data storage unit 151 stores a prototype model (form) being an origin of a prediction model included in an optimization model.

Furthermore, the data storage unit 151 stores data (learning data) used for learning (machine learning) in the model learning unit 153 to be described later. The learning data are not particularly limited. For example, the learning data are data previously stored in the information processing device 101, in relation to the learning in the model learning unit 153 to be described later.

Furthermore, the data storage unit 151 may store data (reference data) used in processing in the model calculation unit 154. The reference data are not particularly limited. For example, the reference data are observation data (e.g. meteorological data) received from predetermined observation equipment.

The prototype model stored in the data storage unit 151 is not particularly limited. For example, the prototype model may be a prediction model related to a regression prediction or another general prediction model.

The model learning unit 153 acquires a prototype model stored in the data storage unit 151. When the data storage unit 151 stores a plurality of prototype models, the model learning unit 153 may select a prototype model in accordance with a predetermined instruction or a preset rule.

Furthermore, the model learning unit 153 executes predetermined processing (e.g. machine learning) by use of data (learning data) stored in the data storage unit 151.

Then, by use of the result of the aforementioned predetermined processing (machine learning), the model learning unit 153 adjusts at least part of the prototype model (e.g. a parameter or a numerical expression) and calculates a prediction model.

The prediction model is a model using a result of machine learning. Accordingly, the prediction model is also referred to as a post-learning model.

For example, when the information processing device 101 uses a prediction model (regression model) including a regression matrix, the model learning unit 153 calculates a regression matrix by use of machine learning based on learning data, and calculates (generates) a prediction model by incorporating the calculated regression matrix into a prototype model.

Learning processing used by the model learning unit 153 is not particularly limited. For example, when learning a regression model, the model learning unit 153 may use a regression model learning engine in general use.

The model learning unit 153 transmits the prediction model to the model calculation unit 154.

The parameter reception unit 152 receives a parameter used by the model calculation unit 154. The parameter received by the parameter reception unit 152 is not particularly limited. The parameter has only to be a variable or a parameter included in an objective function or a constraint in an optimization model. For example, the parameter reception unit 152 may receive the variable λ and/or the initial value y₀ of the variable y that are already described. Thus, the number of parameters received by the parameter reception unit 152 is not particularly limited.

Further, a source of a parameter is not particularly limited. The parameter reception unit 152 may receive a parameter from a device operated by a user.

Alternatively, the information processing device 101 may include unillustrated input equipment, and the parameter reception unit 152 may receive a parameter input to the unillustrated input equipment.

For example, it is assumed that the information processing device 101 includes an unillustrated liquid crystal display. It is further assumed that the information processing device 101 includes as the parameter reception unit 152 a touch panel on a surface of the liquid crystal display. In this case, the information processing device 101 displays a parameter value or an image for setting a parameter value on the liquid crystal display. Then, the parameter reception unit 152 may detect an input operation on the touch panel and acquire a parameter related to a detected position.

The parameter reception unit 152 transmits the received parameter to the model calculation unit 154.

The parameter reception unit 152 may receive a parameter related to a prediction model and transmit the parameter to the model learning unit 153. A broken line in FIG. 5 indicates the relation.

The model calculation unit 154 receives a prediction model from the model learning unit 153. Additionally, the model calculation unit 154 receives a parameter from the parameter reception unit 152. Then, based on the parameter and the prediction model, the model calculation unit 154 generates an optimization model to be transmitted to the model acquisition unit 110. The model calculation unit 154 may use reference data stored in the data storage unit 151 in generation of the optimization model.

Then, the model calculation unit 154 transmits the generated optimization model to the model acquisition unit 110.

From here on, the information processing device 101 calculates an optimum solution, based on an operation similar to that of the information processing device 100 according to the first example embodiment.

### [Description of Operation]

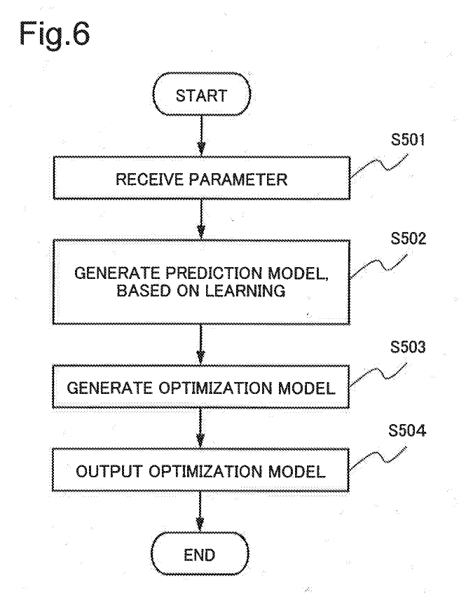

Next, with reference to a drawing, an example of details of the operation of the model generation unit 150 according to the second example embodiment will be described. FIG. 6 is a flow diagram illustrating an operation example of the model generation unit 150 according to the second example embodiment.

The data storage unit 151 previously stores a prototype model (form) and learning data. The data storage unit 151 may further store reference data.

Then, the parameter reception unit 152 receives a parameter from a predetermined source device (Step S501).

As already described, the parameter received by the parameter reception unit 152 is not particularly limited. For example, the parameter reception unit 152 may receive a parameter (e.g. a constraint (λ) of a variation range or an initial value γ₀ of a variable γ) used by the model calculation unit 154. The parameter reception unit 152 transmits the received parameter to the model calculation unit 154.

Alternatively, the parameter reception unit 152 may receive a parameter used for learning by the model learning unit 153. In this case, the parameter reception unit 152 transmits the received parameter for learning to the model learning unit 153.

The model learning unit 153 learns a predetermined part (a parameter such as a regression matrix) in the prototype model by use of the learning data stored in the data storage unit 151. Then, the model learning unit 153 calculates a prediction model by use of the learning result and the prototype model (Step S502).

The model learning unit 153 transmits the prediction model to the model calculation unit 154.

The model learning unit 153 may operate before the parameter reception unit 152. Alternatively, the model learning unit 153 and the parameter reception unit 152 may operate in parallel in at least part of the operations.

The model calculation unit 154 generates an optimization model (e.g. a robust quadratic optimization model) from the prediction model by use of the parameter (Step S503). The model calculation unit 154 may use reference data in calculation of the optimization model.

Then, the model calculation unit 154 outputs (transmits) the optimization model to the model acquisition unit 110 (Step S504).

### [Detailed Operation]

Next, an example of an operation of machine learning in the model learning unit 153 will be described in detail by use of mathematical expressions. However, mathematical expressions used by the model learning unit 153 according to the present example embodiment are not limited to the following description.

First, it is assumed that learning data used for machine learning by the model learning unit 153 are a premeasured explanatory variable being a vector x and a premeasured explained variable being a vector y in a generated prediction model. Accordingly, the number of vectors x and the number of vectors y in the learning data are the same (hereinafter denoted as N where N is a positive integer). When individual vectors x and individual vectors y in the learning data are distinguished, it is assumed that a superscript i (where i is a positive integer) is added to each vector. Specifically, an i-th vector x is denoted as “xⁱ.”

Similarly, it is assumed that an i-th vector y is denoted as “yⁱ.” Note that y is “y=Q₀g(x)” in mathematical expression 3. In other words, yⁱ and Qg(xⁱ) have the same number of elements.

For example, an explanatory variable and an explained variable used as learning data are a sales price and a sales volume of a commodity in a predetermined period.

The model learning unit 153 introduces a matrix G a matrix element of which is expressed in mathematical expression 10 below.

Gᵢⱼ=gⱼ(xⁱ) [Mathematical expression 10]

In mathematical expression 10, the matrix “G” is a matrix including a basis function g(xⁱ) as a row vector. In other words, the matrix G is a matrix the i-th row of which includes the basis function g(xⁱ) being a column vector, the function being transformed into a row vector. Further, “gⱼ(xⁱ)” is the j-th element of the basis function g(xⁱ) related to an i-th vector xⁱ. In other words, an element “Gᵢⱼ” in the i-th row and the j-th column of the matrix G is the j-th element of the basis function g(xⁱ) related to the i-th vector xⁱ.

Then, the model learning unit 153 introduces (calculates) matrices Σ and Δ indicated in mathematical expression 11 below.

$$Σ := \frac{1}{N - 1} {\sum }_{i = 1}^{N} ( {y}^{i} - {Q}_{0} g ( {x}^{i} ) ) {( {y}^{i} - {Q}_{0} g ( {x}^{i} ) )}^{T} \\ Δ := {( {GG}^{T} )}^{- 1} + {E}_{1} \qquad [ Mathematical expression 11 ]$$

In mathematical expression 11 a matrix “E₁” is a matrix having an element “1” in the first row and the first column, and the remaining elements being “0.” The model learning unit 153 calculates the matrices Σ and Δ by applying the vectors x and y in the learning data to mathematical expression 11.

Then, as illustrated in mathematical expression 12, based on the aforementioned matrices Σ and Δ, the model learning unit 153 calculates matrices L₁ and L₂ being square roots of the matrices Σ and Δ, respectively, as a result of the machine learning.

L₁←Σ^{1/2}

L₂←Δ^{1/2} [Mathematical expression 12]

In mathematical expression 12, a square root of a matrix is a general square root of the matrix. For example, the matrix Σ is given by “Σ=L₁^{T}L₁.”

The model learning unit 153 generates a prediction model by applying the aforementioned matrices L₁ and L₂.

The model calculation unit 154 generates an optimization model, based on the aforementioned learning result (prediction model).

### Specific Application Examples

For example, a common retail store handles a large amount of commodities. In other words, a common retail store prefers to calculate an optimum solution of a sales price for each commodity maximizing a total sales amount of a large amount of commodities.

However, work of defining an objective function in an optimization model related to a case as described above is considerably troublesome work, and realistically, is not work executable by an employee of a retail store.

For example, when a future demand prediction line of a commodity at a retail store is acquired, it is theoretically possible to calculate an optimum solution for ordering and stocking, based on the demand prediction line. However, there is a natural limit to the number of demand prediction lines (number of commodities) that can be actually generated by a person (employee). Further, ordering work is often performed several times a day. Accordingly, it is realistically impossible for an order person to execute generation of a demand prediction line or the like every time ordering work is performed.

Further, for example, in order to calculate an optimum solution of a commodity price in a certain period in the future in such as way to maximize a sales amount in the period, it is required to grasp a complicated correlation between a price of a large amount of commodities and a demand for the commodities. However, it is considerably difficult work for a person to grasp the correlation for the large amount of commodities.

On the other hand, in general, a large amount of data can be easily processed by an information processing device such as a dedicated calculator or a computer, in accordance with a predetermined procedure. For example, it is assumed that the data storage unit 151 in the model generation unit 150 stores a definition of a “form (prototype model)” of an objective function. Then, it is further assumed that the model learning unit 153 generates a prediction model from the prototype model, based on a large amount of learning data being combinations of sales prices and sales volumes of the respective commodities in the case of the aforementioned retail store. Processing in this case is processing that can be performed in the model learning unit 153. Thus, the model generation unit 150 is able to efficiently generate an optimization model in a situation in which a large amount of data exist.

Furthermore, even when using a plurality of pieces of large-sized data among which a complicated correlation such as a cannibalization relation described in the first example embodiment exists, the model generation unit 150 is able to generate an optimization model as long as a procedure therefor is defined.

As already described, a device calculating a general optimum solution does not consider a prediction error. Accordingly, an optimum solution calculated by the common device may not be optimum when actually applied. Accordingly, an optimum solution calculated by the device calculating a general optimum solution requires a determination and/or adjustment based on manual work.

By contrast, the information processing device 101 calculates a robust optimization model considering a prediction error. Alternatively, the information processing device 101 is able to determine a suitable uncertain domain, based on a specified probability. The specification of a probability will be described later as a third example embodiment.

Accordingly, the information processing device 101 is able to provide calculation of an optimum solution in an optimization model robust to a prediction error due to a large amount of data, the calculation being difficult to be performed by manual work.

In calculation of a prediction model, the model learning unit 153 may execute machine learning by use of external information.

For example, the external information includes the weather, a season, a situation in a surrounding area (e.g. an event being held), a rate of an equivalent product in a surrounding area, or location information (e.g. a residential area, a business district, and a distance from a station).

### [Description of Effects]

Next, effects of the information processing device 101 according to the second example embodiment will be described.

In addition to the effect of the first example embodiment, the information processing device 101 according to the second example embodiment provides an effect of providing a suitable optimization model.

The reason is as follows.

The model learning unit 153 generates a prediction model by applying a result of machine learning to a prototype model previously stored in the data storage unit 151. Then, the model calculation unit 154 generates an optimization model by applying a parameter received by the parameter reception unit 152 to the prediction model. In other words, the model generation unit 150 is able to calculate a suitable optimization model, based on machine learning, and provide the model for the model acquisition unit 110.

### Third Example Embodiment

The information processing device 100 and the information processing device 101 may receive a parameter value in an optimization model, based on an operation by a user or the like, and calculate an optimum solution by applying the value to the optimization model. Alternatively, the information processing device 100 and the information processing device 101 may receive an instruction for changing a parameter value, based on an operation by a user or the like, and calculate an optimum solution by changing the parameter value in an optimization model.

Furthermore, the information processing device 100 and the information processing device 101 may display an optimum solution associated with a received parameter.

Then, as a third example embodiment, an information processing device 800 including the function of the information processing device 100 or the information processing device 101, and further receiving a parameter and outputting an optimum solution will be described. The information processing device 100 will be used as an example in the following description. However, the information processing device 100 is replaceable with the information processing device 101 in the following description. Further, the information processing device 800 may be configured by use of the computer illustrated in FIG. 3.

### [Assumptions in Description]

It is assumed in the following description that an objective function in an optimization model is a total sales amount being a total of sales of a plurality of commodities (hereinafter simply referred to as a “sales amount”). The sales amount (the objective function, i.e. a merit) is a total of products of sales prices of the respective commodities and sales volumes of the respective commodities.

A sales volume of each commodity is influenced by a sales price of each commodity. The matrix Q₀ in mathematical expression 5 is a matrix indicating the influence relation (e.g. a cannibalization relation). Thus, a sales volume of a commodity is a value (predicted value) expressed by use of functions (prediction formulae) of sales prices of the commodities. In other words, a prediction model included in the optimization model is a model predicting a sales volume of a commodity, based on sales prices of the commodities. Specifically, a sales price of each commodity is an explanatory variable (vector x) in the prediction model. Further, a sales volume of each commodity is an explained variable (vector y) in the prediction model.

Then, the optimization model calculates a sales price optimizing (maximizing a minimum value in a variation range) the sales amount being the objective function. In other words, a target variable in the optimization model is a sales price (vector x) of each commodity.

### [Description of Configuration]

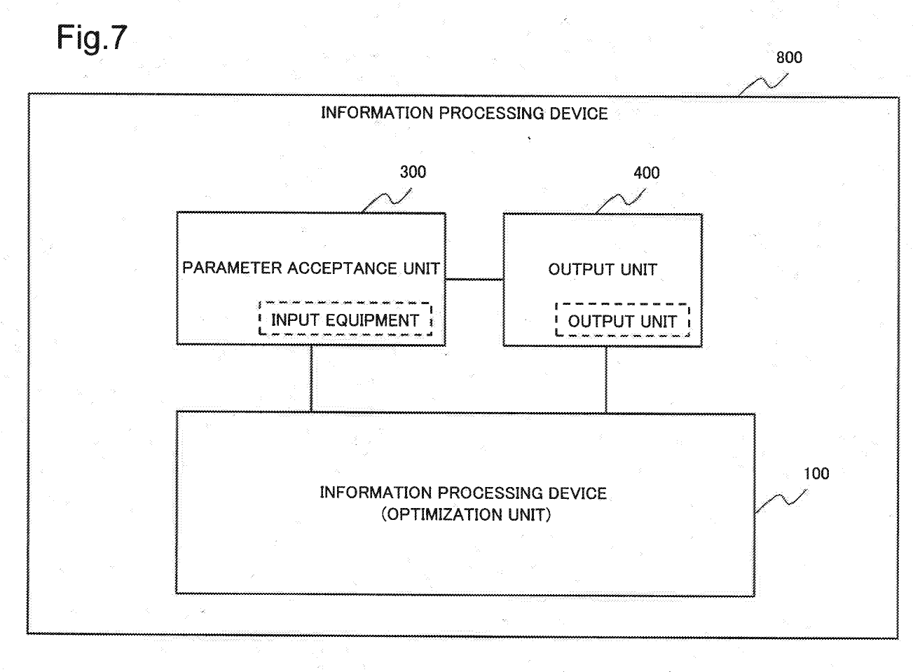

FIG. 7 is a diagram illustrating a configuration example of the information processing device 800 according to the third example embodiment.

As illustrated in FIG. 7, the information processing device 800 includes the information processing device 100, a parameter acceptance unit 300, and an output unit 400.

The parameter acceptance unit 300 accepts (receives) an input of a parameter probabilistically indicating a range of variation (prediction error) in an optimization model (robust optimization model) for which the information processing device 100 calculates an optimum solution.

The parameter is an example of an indicator. Accordingly, the parameter acceptance unit 300 is an example of an indicator acceptance unit.

More specifically, for example, when a distribution of an optimum value of the aforementioned sales amount is expressed by use of a probability density, the parameter is a parameter probabilistically indicating a range of a prediction error at the optimum value of the sales amount. “Probabilistically indicating” means indicating by use of an indicator related to a probability. For example, “probabilistically indicating” means a ratio (percent) of a probability density to an entire distribution or a ratio to a standard deviation (σ) in a probability density.

The parameter may be a parameter related to a probability with respect to a possibility of being subjected to an unexpected disadvantage (risk). By contrast, the parameter may be a parameter related to a probability with respect to a possibility of being subjected to an expected disadvantage (risk). Thus, the parameter is a value related to a possibility of being subjected to an unexpected disadvantage (risk).

An example of the parameter will be described below by use of the ‘variable λ (hereinafter referred to as a “parameter λ”)’ indicated in mathematical expression 5. The parameter λ is an example of data indicating a range of a prediction error.

A more specific example of “probabilistically indicating” with respect to the parameter λ will be described. It is assumed that a probability distribution used in the description is a standard normal distribution. It is further assumed that α is a ratio (in percent [%]) of a risk not considered in calculation of an optimum solution in a probability distribution.

A value of α being 50 relates to considering an average. In other words, the case of “α=50” relates to a general optimization (non-robust optimization).

Accordingly, it is assumed that a value of α is 50 or less. Then, a distribution function related to the aforementioned probability distribution is denoted as a function F( ). In this case, the information processing device 100 may use a value indicated in mathematical expression 13 below as the parameter λ.

$$λ = {F}^{- 1} ( \frac{100 - α}{100} ) \qquad [ Mathematical expression 13 ]$$

In mathematical expression 13, F⁻¹( ) denotes an inverse function of the function F( ).

The acceptance technique of the parameter λ, in the parameter acceptance unit 300 is not particularly limited. For example, the parameter acceptance unit 300 may include unillustrated input equipment (e.g. a keyboard, a mouse, or a touch panel) and accept the parameter λ, based on an operation on the input equipment. Accordingly, FIG. 7 uses a broken line to indicate the input equipment.

Alternatively, the parameter acceptance unit 300 may receive the parameter λ from a device operated by a user through an unillustrated network.

Similarly to the first example embodiment, the information processing device 100 calculates an optimum solution in an optimization model (robust optimization model). Specifically, the information processing device 100 calculates a price of a commodity in such a way as to maximize a value of an objective function under a constraint, with respect to the objective function indicating a sales amount including and being determined by a product of a sales price of the commodity and a sales volume of the commodity. The calculated commodity price is the optimum solution in the optimization model.

More specifically, the information processing device 100 calculates an optimum solution maximizing a minimum value of the sales amount (objective function) within a variation range (prediction error) probabilistically specified based on the parameter λ.

Thus, the information processing device 100 serves as an optimization unit in the information processing device 800.

The output unit 400 outputs an optimum solution (sales price) calculated by the information processing device 100, the solution being associated with at least the parameter λ (a value indicating a prediction error range). However, the output method in the output unit 400 is not particularly limited. For example, the output unit 400 may include unillustrated display equipment (e.g. a liquid crystal display) and display the optimum solution and the parameter λ on a single screen. Accordingly, FIG. 7 indicates the display equipment by use of a broken line.

Alternatively, the output unit 400 may output the optimum solution and the parameter λ to a predetermined output device.

In addition to the aforementioned information (the optimum solution and the parameter λ), the output unit 400 may output information related to the optimization model, the information being associated with the aforementioned information. For example, in addition to the aforementioned information, the output unit 400 may output a value of the vector y (a predicted value of a sales volume of a commodity) being an explained variable in the prediction model and/or a value of the objective function in the optimization model (an optimum value of the sales amount).

The output unit 400 may acquire information related to the aforementioned optimization model and the prediction model included in the optimization model as needed from the information processing device 100 and/or the parameter acceptance unit 300.

Furthermore, the parameter acceptance unit 300 may accept the parameter λ again after the output unit 400 outputs the optimum solution and the parameter λ. For example, the output unit 400 includes display equipment and displays the optimum solution and the parameter λ on the display equipment. A user of the information processing device 800 refers to the display and inputs a value of a parameter λ to be checked (a new parameter λ) to the information processing device 800.

The input method is not particularly limited. For example, the parameter acceptance unit 300 may include input equipment and acquire the parameter λ, based on an operation on the input equipment. Alternatively, a user device connected to the information processing device 800 through a network may transmit a new parameter π to the information processing device 800.

The information processing device 800 operates similarly to the operation already described and calculates an optimum solution related to the new parameter λ. Then, the information processing device 800 outputs the new parameter λ and the optimum solution, the two being associated with one another.

The number of parameters λ that can be accepted by the information processing device 800 is not particularly limited. The information processing device 800 may accept one parameter λ and calculate an optimum solution. Alternatively, the information processing device 800 may accept a plurality of parameters λ, calculate an optimum solution related to each parameter λ, and output the parameters λ and the optimum solutions, the two being associated with one another.

In the description up to this point, it is assumed that the information processing device 800 accepts a parameter λ by use of the parameter acceptance unit 300. However, the information processing device 800 may operate on a preset parameter λ.

For example, the information processing device 800 previously stores a plurality of values of the parameter λ (e.g. values related to probabilities 10%, 20%, 30%, and 40% of a considered risk or an unconsidered risk) in an unillustrated storage unit. Then, the parameter acceptance unit 300 transmits the stored parameters λ to the information processing device 100. The information processing device 100 calculates an optimum solution related to each parameter λ. Then, the output unit 400 outputs each parameter λ and the optimum solution related to the parameter λ, the two being associated with one another.

A user of the information processing device 800 may refer to the information output by the output unit 400 (sets of an optimum solution and a parameter λ) and select an optimum solution.

In this case, the information processing device 800 may accept a new parameter λ, based on a user operation, and calculate a new optimum solution. For example, there is a case that a user may want to know an optimum solution between two values of parameters λ (e.g. a detailed optimum solution between probabilities 20% and 30% of a considered risk). In such a case, the information processing device 800 may accept the parameter λ for which an optimum solution is wanted, calculate an optimum solution, and output the parameter λ and the optimum solution, the two being associated with one another.

### Display Example

Next, with reference to drawings, an output of the output unit 400 in the information processing device 800 according to the third example embodiment will be described. The following description describes a case that the output unit 400 includes display equipment and displays a parameter λ and an optimum solution by use of the display equipment.

### First Display Example

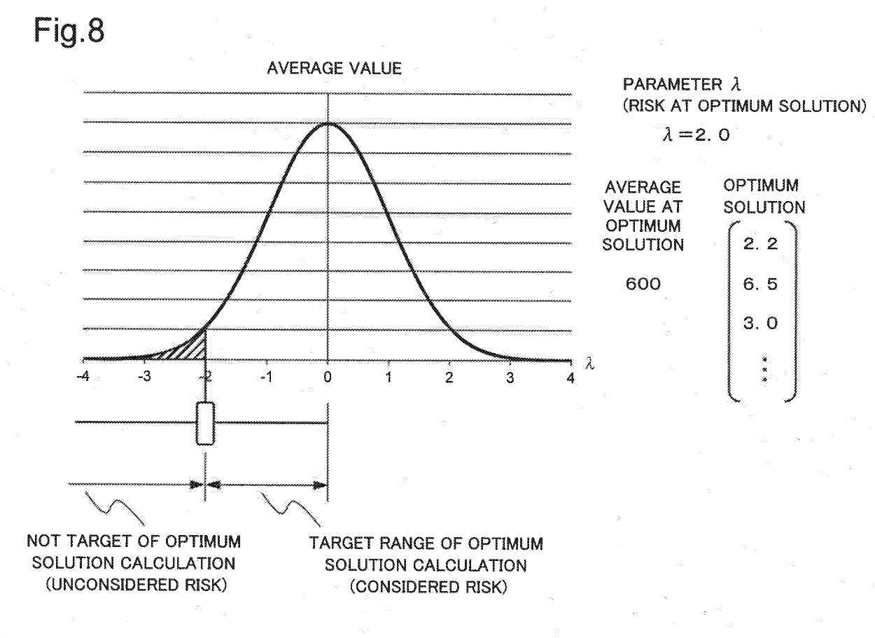

FIG. 8 is a diagram illustrating a first display example at the output unit 400 according to the third example embodiment. FIG. 8 is a diagram illustrating an example of displaying an accepted parameter λ and a related optimum solution.

FIG. 8 illustrates an example of a probability density function of a value of an objective function (optimum value) having a normal distribution. In the normal distribution illustrated in FIG. 8, the position of “λ=0” is the position of the average value of the normal distribution. Then, in FIG. 8, a range at the right of the average value is a range in which a value of the objective function is a good value. In other words, a range in which λ takes a positive value is a range in which a value of the objective function is greater than the average (a sales amount is high). By contrast, a range at the left of the average (a range in which λ takes a negative value) is a range in which a value of the objective function is less than the average (a sales amount is low). The probability density function used by the information processing device 800 is not limited to a normal distribution.

A rectangle illustrated in the lower part of FIG. 8 indicates a value of the parameter λ. Specifically, a position of the rectangle in FIG. 8 indicates a lower limit of an uncertainty range used as a target of calculation of an optimum solution. In other words, the position of the rectangle relates to a value of the parameter λ. A range in which a sales amount is greater than the average represents a more preferred result and therefore occurrence thereof involves no problem. Then, a range of a risk unconsidered (unused) for calculation of an optimum solution becomes a range below the average. In other words, a range at the left of the position relating to the parameter λ (a shaded range) in FIG. 8 is a range related to an unconsidered risk which is an uncertainty range not used for calculation of an optimum solution. In other words, the graph illustrated in FIG. 8 indicates magnitude of an unconsidered risk related to the parameter λ. An unshaded range is a range of a risk considered for calculation of an optimum solution. Accordingly the graph illustrated in FIG. 8 is also a diagram indicating magnitude of a considered risk related to the parameter λ.

Furthermore, as illustrated in the right-hand part of FIG. 8, the output unit 400 displays a value of the parameter λ (a risk related to the optimum solution) and values of the optimum solution related to the parameter λ (prices of commodities [in thousand yen]). Since a risk is a difference from the average, a range of a considered risk in FIG. 8 is a part ranging from the average (λ=0) to the parameter λ.

In FIG. 8, in addition to the above, the output unit 400 displays an optimum value of the objective function at a value of the parameter λ (the average value of the sales amount in the optimum solution, in thousand yen).

When the parameter acceptance unit 300 accepts a new parameter λ, the information processing device 800 calculates an optimum solution related to the parameter λ. Then, the output unit 400 displays the new parameter λ and the related optimum solution.

For example, it is assumed that the parameter acceptance unit 300 includes, as input equipment, a touch panel installed on a surface of display equipment included in the output unit 400. Then, the parameter acceptance unit 300 detects an operation of shifting a rectangle relating to a displayed parameter λ, to the right or left by use of the touch panel. Then, the parameter acceptance unit 300 may use the parameter λ related to the operation position on the touch panel as a new parameter λ. When the information processing device 800 includes such a configuration, a user of the information processing device 800 may change the parameter λ.

As described above, a value of the parameter λ, becomes a negative value in FIG. 8. In other words, a positive value of the parameter λ does not need to be used in this display example. Accordingly, the output unit 400 may omit a “−” sign in a value of the parameter λ. Accordingly, the “−”sign in the value of the parameter λ is omitted in FIG. 8.

As a display of the parameter λ, the output unit 400 may display a probability value (e.g. a percent value of an unconsidered risk or a considered risk) related to a value of the parameter λ, in place of the value of the parameter λ.

When a value of the parameter λ is “0,” the information processing device 800 calculates an optimum solution in an optimization model not using a prediction error range (risk) (i.e. a general optimization model). Further, when an absolute value of the parameter λ is a maximum value in a settable range, the information processing device 800 calculates an optimum solution in an optimization model (robust optimization model) using every settable prediction error range (risk).

However, an operation target in the information processing device 800 is not limited to the parameter λ. Further, the number of parameters displayed and operated by the information processing device 800 is not limited to one. The information processing device 800 may operate and display a plurality of parameters.

### Second Display Example

The information processing device 800 may display a plurality of optimum solutions. For example, in order to compare optimum solutions related to a change of the parameter λ, the information processing device 800 may display an optimum solution before the change of the parameter λ and an optimum solution after the change.

Alternatively, the information processing device 800 may display a plurality of parameters λ and optimum solutions related to the respective parameters λ.

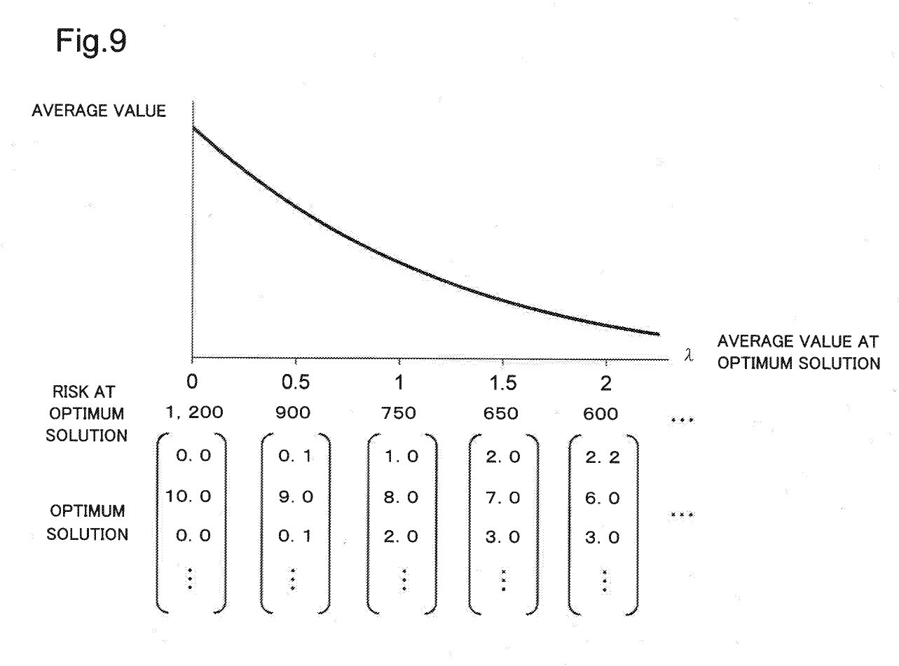

FIG. 9 is a diagram illustrating a second display example at the output unit 400 according to the third example embodiment.

In FIG. 9, a graph in the upper part is a graph illustrating an example of change in a value of an objective function (optimum value) with respect to a variable λ.

The vertical axis in the graph indicates a value of the objective function (an average value of an optimum value of a sales amount). In order to make the graph easy to recognize, an intersection with the horizontal axis on the vertical axis is shifted from zero.

The horizontal axis indicates a value of the parameter λ.

As described above, the parameter λ has a negative value. Accordingly, in order to make a relation between the parameter λ and an optimum solution easy to recognize, display of a positive value of the parameter λ is omitted in FIG. 9. Additionally, in FIG. 9, display of the “−” sign is omitted, and a range of negative values of the parameter λ is displayed in such a way that an absolute value of the parameter λ increases toward the right-hand side of the diagram. Further, the diagram indicates a case that a probability density related to an optimum value of the objective function is monotonically decreasing.

The lower part of FIG. 9 indicates values of an optimum solution (commodity prices in thousand yen) with respect to each parameter λ. Additionally, the output unit 400 displays a value of an optimum value (an average value of a sales amount in thousand yen) of the objective function related to each optimum solution.

The parameter acceptance unit 300 accepts values of a plurality of parameters λ (risks). Then, the information processing device 100 calculates optimum solutions (commodity prices) related to the parameters λ. Then, the output unit 400 displays the plurality of optimum solutions (commodity prices) calculated by the information processing device 100 and the parameters λ (risks) related to the respective optimum solutions on a single screen, the two being associated with one another.

In addition to the aforementioned information (the optimum solution and the parameter λ), the output unit 400 displays an optimum value of the objective function (an average value of a sales amount) related to each optimum solution (commodity prices).

In the case of the second display example illustrated in FIG. 9, a user of the information processing device 800 is able to check a relation between a plurality of risks (parameters λ) and optimum solutions on a single screen.

The information processing device 800 may calculate an optimum solution related to not only the parameter λ but also another parameter or a plurality of parameters, and display the result.

### [Description of Effects]

Next, an effect of the information processing device 800 according to the third example embodiment will be described.

The information processing device 800 according to the third example embodiment provides an effect of providing (outputting) an optimum solution of a price optimizing a sales amount related to a relation with a parameter λ (risk) indicating a prediction error range.

The reason is as follows.

The parameter acceptance unit 300 accepts a parameter λ. The parameter λ is a value related to magnitude of a risk (prediction error range). The information processing device 100 calculates, under a constraint, an optimum solution (optimum commodity price) maximizing a minimum value of a value of an objective function (sales amount) (merit) including and being determined by a product of a commodity price and a sales volume of the commodity. The optimum solution is a value for achieving a value of the objective function (merit). In other words, the optimum solution is a value related to a value of the objective function (merit). Then, the output unit 400 outputs the optimum solution and the parameter k, the two being associated with one another. Thus, the information processing device 800 calculates and outputs an optimum solution related to a relation between a risk and a merit.

### Modified Example

As already described, the output unit 400 in the information processing device 800 may transmit an optimum solution and a parameter λ to another device. For example, when a management device in a system including a plurality of terminal devices includes the information processing device 800, the information processing device 800 or the aforementioned management device may transmit a combination of an optimum solution calculated by the information processing device 800 and a parameter λ to each terminal device.

The above will be more specifically described by use of a point of sale system (POS system). It is assumed that a management device in the POS system includes the information processing device 800. In this case, the management device in the POS system transmits combinations of an optimum solution (commodity price) and a parameter λ to a terminal device at each store. A user of each terminal device (e.g. a store manager at each store) may select a parameter λ related to a risk at each store, based on a state of each store (e.g. a location and business hours of the store) and use an optimum solution (commodity price) related to the selected parameter λ.

In this case, the management device may use, as an optimization model being a processing target of the information processing device 800, an optimization model of the entire POS system combining optimization models at the respective stores. In this case, the information processing device 800 may use as a constraint in the optimization model a constraint reflecting a constraint at each store (e.g. a stock quantity at each store). In other words, the information processing device 800 is able to calculate an optimum solution by use of a more accurate optimization model.

Furthermore, the information processing device 800 included in the management device may receive a parameter λ from each terminal device. For example, when a user of a terminal device wants to know an optimum solution for a parameter λ between two received parameters λ, the user of the terminal device may operate the terminal device and transmit to the management device a value of the parameter λ for which an optimum solution is to be calculated.

In the case of the aforementioned POS system, information to be transmitted may include an explained variable in a prediction system (a predicted value of a sales volume of each commodity) or an objective function (sales amount), in addition to optimization and a parameter λ. In that case, for example, a user of each terminal device may further add a determination criterion (e.g. a stock quantity at the store) to the selection of an optimum solution. In other words, a user of the information processing device 800 is able to more accurately select an optimum solution.

### Other Example Embodiments

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from U.S. provisional application No. 62/290,564, filed on Feb. 3, 2016, the disclosure of which is incorporated herein in its entirety by reference.

What is claimed is:

1. An information processing device comprising:
a memory; and
at least one processor coupled to the memory wherein,
the processor performing operation, the operation comprising:
acquiring an optimization model for calculating an optimum solution considering variation in one or more parameters;
calculating the optimum solution in the optimization model;
transforming the optimization model based on the optimum solution; and
outputting the optimum solution.

2. The information processing device according to claim 1, wherein,
the operation further comprises
transforming the optimization model in such a way as to search for a minimum value in a range of the variation in the parameters in the optimization model by use of the calculated optimum solution, and
calculating the optimum solution in the transformed optimization model.

3. The information processing device according to claim 2, wherein
the operation of transforming the optimization model and the operation of calculating the optimum solution are repeated until a predetermined condition is satisfied.

4. The information processing device according to claim 1, wherein
the operation further comprises:
generating the optimization model based on the parameters in the optimization model.

5. The information processing device according to claim 4, wherein
the operation further includes:
storing a prototype model being a model used in generation of the optimization model, and learning data;
generating a post-learning model acquired by adjusting the prototype model based on machine learning using the learning data;
receiving at least part of the parameters in the optimization model; and
generating the optimization model based on the parameters and the post-learning model.

6. An information processing method comprising:
acquiring an optimization model for calculating an optimum solution considering variation in one or more parameters;
calculating the optimum solution in the optimization model;
transforming the optimization model based on the optimum solution; and
outputting the optimum solution.

7. A non-transitory computer-readable recording medium embodying a program, the program causing a computer to perform a method, the method comprising:
acquiring an optimization model for calculating an optimum solution considering variation in one or more parameters;
calculating the optimum solution in the optimization model;
transforming the optimization model, based on the optimum solution; and
outputting the optimum solution.
